(19) United States
(12) Patent Application Publication
(10) Pub. No.: US 2010/0058979 A1
(43) Pub. Date: Mar. 11, 2010

(54) SHEATHLIKE APPLICATOR AND PROCESS FOR PRODUCING THE SAME

(76) Inventors: Koji Nakamura, Osaka-shi (JP); Bernard Pauchet, Prigonrieux (FR); Michel Guimard, Prigonrieux (FR)

Correspondence Address: KNOBBE MARTENS OLSON & BEAR LLP, 2040 MAIN STREET, FOURTEENTH FLOOR, IRVINE, CA, 92614, US

(21) Appl. No.: 12/303,644

(22) PCT Filed: May 28, 2007
(86) PCT No.: PCT/JP2007/060775

§ 371 Date: Nov. 23, 2009

(30) Foreign Application Priority Data
Jun. 6, 2006 (JP) 2006-157012

(51) Int. Cl. B05C 1/00; B32B 37/02

(52) U.S. Cl. 118/200; 156/250

(57) ABSTRACT

A sheath-shaped application implement, as well as a manufacturing method thereof, where said sheath-shaped application implement comprises a base sheet(s) and a protective film(s) that are sealed together in a manner providing an empty area in which to insert the palm or fingers, and at least one base sheet mentioned above is constituted by a retention layer having at least one type of application composition on it, and by a barrier layer, where the barrier layer prevents permeation or leakage of the application composition, while the protective film is structured in such a way as to protect the application composition from exposure to the outside. This application implement can be stored in a manner retaining the quality of the application composition, is not bulky, can be carried with ease, and when used the application implement allows the protective film to be removed with ease and the application composition to be applied to desired locations at various parts of the body.

### TECHNICAL FIELD

The present invention relates to a sheath-shaped application implement that is not bulky and can be carried easily, comprising a sheet member and a protective film, having a palm or finger insertion part, and retaining an application composition inside.

To be more specific, the present invention relates to a sheath-shaped application implement that allows the quality of the application composition to be retained while in storage, and when in use the protective film covering the application composition can be easily removed and the application composition can be applied to desired areas of the skin without getting the hand, palm or fingertips dirtied by the application composition seeping, oozing, permeating or leaking out (these conditions are hereinafter collectively referred to as “permeate or leak” or “permeation or leakage”) .

### PRIOR ART

Technologies for applying a cosmetic material or other application composition to specified locations on the face, neck and other parts of the body in a simple and convenient manner had been proposed by the inventors of the present invention in the past.

For example, the inventors of the present invention had proposed a sheath-shaped bag made of a member formed in a specified sheath shape and containing a skin preparation for external use, as described in Japanese Patent Laid-open No. 2000-79016 (Patent Literature 1). The aforementioned sheath-shaped bag is used to apply the skin preparation for external use onto the skin surface with the user inserting not the entire palm, but only the fingertips, into the sheath-shaped bag. Since only the fingertips are used to apply the preparation, however, only a small amount can be applied and the hand and palm became dirty with ease.

Also, bags having a separate structure comprising two chambers each storing an application composition and an application member, as proposed in Japanese Utility Model Laid-open No. Sho 63-67442 (Patent Literature 2) and Japanese Utility Model Laid-open No. Hei 4-56639 (Patent Literature 3), are also known. However, these bags require the two chambers to be opened first and then the application composition must be absorbed by the application member, which is rather bothersome. Also, these bags make the hand dirty.

Furthermore, the inventors of the present invention had earlier proposed technologies described in Japanese Patent Laid-open No. 2003-180449 (Patent Literature 4) and Japanese Translation of PCT Patent Application No. 2005-511443 (Patent Literature 5), where said technologies are characterized in that a glove-shaped application member in which a skin preparation for external use is adsorbed is packed and sealed to an airtight condition, and a part of the package bag is separated to remove the application member to which the skin preparation for external use is attached, after which the palm is inserted into the application member to apply the cosmetic material (skin preparation for external use), as shown in FIG. 1. If the application composition has high viscosity, however, these technologies do not easily allow the application composition to be adsorbed evenly by the composition member, which makes these technologies unusable with highly viscous cosmetic materials. There are also limitations with these technologies in terms of general utility, because only one type of compositions can be used.

Another technology similar to the aforementioned technologies is described in British Patent Laid-open No. 2108921A (Patent Literature 6), where said technology is specifically an application implement comprising an applicator integrally packed in a package bag. However, this application implement requires a cumbersome operation to open the package at the time of use, and presents other drawbacks such as the user not able to use the application surface effectively and getting the hands and clothes dirty inadvertently. From the manufacturing standpoint, a process to bend the applicator is required, which gives rise to a possibility of wrinkling. Also, positioning the applicator when it is joined with the package bag is difficult and there are many other factors that can lower the product yield.

On the other hand, technologies are presented in U.S. Pat. No. 6,322,798 (Patent Literature 7) and International Patent Laid-open No. WO2004/110414 (Patent Literature 8), whereby a single package body is used to store different substances in a manner isolating them from each other, and when the package is used the two substances are mixed and the mixture is applied. However, these methods require very cumbersome operations to open the package and mix the substances.

Patent Literature 1: Japanese Patent Laid-open No. 2000-79016

Patent Literature 2: Japanese Utility Model Laid-open No. Sho 63-67442

Patent Literature 3: Japanese Utility Model Laid-open No. Hei 4-56639

Patent Literature 4: Japanese Patent Laid-open No. 2003-180449

Patent Literature 5: Japanese Translation of PCT Patent Application No. 2005-511443

Patent Literature 6: British Patent Laid-open No. 2108921A

Patent Literature 7: U.S. Pat. No. 6,322,798

Patent Literature 8: International Patent Laid-open No. WO2004/110414

### SUMMARY OF THE INVENTION

### Problems to Be Solved by the Invention

In light of the problems presented by conventional products as mentioned above, the present invention aims to provide a compact sheath-shaped application implement that: encases an application composition such as a cosmetic material or skin preparation for external use, as well as a base sheet, in a thin, flexible manner; provides an excellent property to retain the quality of the application composition; allows the application composition to be adsorbed by the retention layer evenly regardless of the viscosity of the application composition; prevents permeation or leakage of the application composition to the hand or fingers; permits easy opening when the application implement is used; and allows for an application operation targeting desired areas of the face, skin and other parts of the body without dirtying the hand or fingers.

The present invention also aims to provide a sheath-shaped application implement that separately stores different types of application compositions without allowing them to mix together until use, and when the application implement is used these different application compositions can be freely mixed and used by means of a simple operation of smearing an appropriate amount of the mixture onto the skin of the face, etc.

In addition, the present invention aims to provide a sheath-shaped application implement that separately stores and isolates the constituents of an application composition where the constituents become unstable when they are mixed, in order to retain the activity of the constituents until immediately before use, and when the application implement is used the activity of the aforementioned constituents can be utilized fully and effectively.

Furthermore, the present invention aims to provide a sheath-shaped application implement that has different types of application compositions impregnated in or placed on both sides of a base material, in order to demonstrate the combined effects of the application compositions or other effects obtained by mixing the multi-functional application compositions at the time of use.

Furthermore, the present invention aims to provide a highly efficient continuous production method for manufacturing a sheath-shaped application implement at high yield, wherein said production method is characterized by a control technology to selectively seal the specified location of a specified sheet material without requiring a cumbersome process, even when multiple sheets are overlaid on top of one another, and by another technology to separately store a specified application composition in each target compartment in a reliable manner.

### Means for Solving the Problems

To achieve the aforementioned aims, the present invention provides a sheath-shaped application implement having a base sheet, protective film and application composition, wherein said sheath-shaped application implement also has an empty area in which to insert the palm or fingers, and the aforementioned base sheet has at least on one side (a) a retention layer on which the application composition is placed and (b) a barrier layer to prevent the application composition from permeating or leaking to the aforementioned empty area in which to insert the palm or fingers, while the aforementioned protective film protects the aforementioned retention layer so as to prevent the aforementioned application composition from being exposed to the outside, and together the aforementioned base sheet and protective film are sealed at the sealed parts in a removable manner.

The first invention proposed by the present invention is a sheath-shaped application implement having one, two or more sealed compartments between a base sheet and protective film for placing an application composition inside, and the base sheet and protective film are sealed roughly around their outer peripheries so as to form an empty area in which to insert the palm or fingers, where said sheath-shaped application implement is characterized in that the base sheet has a retention layer and the application composition is placed on its surface, as well as a barrier layer for preventing the application composition from permeating or leaking to the side of the empty area, and the protective film can be removed along the sealed parts around the outer periphery.

The second invention is a sheath-shaped application implement according to the first invention, characterized in that the barrier layer of the base sheet is placed on the side contacted by the palm or fingers, and the base sheet and protective film are sealed roughly around their outer peripheries in a manner forming an empty area in which to insert the palm or fingers.

The third invention is a sheath-shaped application implement according to the first or second invention, characterized in that the outer peripheries that have been sealed, except for the opening to accommodate the palm or fingers to form the empty area 18 in which to insert the palm or fingers, are shaped roughly as a bag, mitten or glove.

The fourth invention is a sheath-shaped application implement according to any one of the first through third inventions, characterized in that the aforementioned one, two or more compartments provided on at least one base sheet each have at least one type of application composition placed inside.

The fifth invention is a sheath-shaped application implement according to any one of the first through fourth inventions, characterized in that the application composition is placed on the retention layer in a line, lattice or surface pattern.

The sixth invention is a sheath-shaped application implement according to any one of the first through fifth inventions, characterized in that at least the base sheet, protective film or both have a color and/or printed pattern.

The seventh invention is a sheath-shaped application implement according to any one of the first through sixth inventions, characterized in that the base sheet is a laminate constituted by a fiber sheet and/or sponge sheet and a resin sheet having a barrier function.

The eighth invention is a sheath-shaped application implement according to any one of the first through seventh inventions, characterized in that the application composition is a composition selected from the group that includes skin care cosmetic materials, cleansing cosmetic materials, makeup cosmetic materials, hair or scalp care preparations for external use, sun care cosmetic materials, tanning cosmetic materials, hair colors, cosmetic materials used as mascara, cooling agents and cleansing materials.

The ninth invention is a sheath-shaped application implement according to any one of the first through eighth inventions, characterized in that the aforementioned base sheet, protective film or both contain a biodegradable substance.

The tenth invention is a sheath-shaped application implement according to any one of the first through ninth inventions, characterized in that the biodegradable substance consists to at least one type of constituent selected from the group that includes polylactic acid, polycaprolactone, aliphatic polyester, bacteria-derived poly 3-hydroxy alkanate, polyamino acid, polyvinyl alcohol, pullulan, celluloses or cellulose-chitosan mixtures.

The eleventh invention is a manufacturing method for sheath-shaped application implement, consisting of the following steps:
(i) a step to place a base sheet constituted by a retention layer and a barrier layer;
(ii) a step to place at least one type of application composition in at least one location on the retention layer;
(iii) a first sealing step to overlay the base sheet and protective film on top of each other in a manner covering the application composition so as to form a closed area;
(iv) a second sealing step to further form an empty area in which to insert the palm or finger by orienting the base sheet with its barrier layer facing inside; and
(v) a cutting step

The twelfth invention is a manufacturing method for sheath-shaped application implement according to the eleventh invention, characterized in that in the aforementioned second sealing step, sealing is performed in such a way that the opening through which to insert the palm or fingers remains as a non-sealed part.

The thirteenth invention is a manufacturing method for sheath-shaped application implement according to the eleventh or twelfth invention, characterized in that in the aforementioned first sealing step in (iii), the protective film and base sheet are sealed in such a way that at least one compartment is formed.

The fourteenth invention is a manufacturing method for sheath-shaped application implement according to any one of the eleventh through thirteenth inventions, characterized in that a barrier layer to prevent permeation or leakage of the application composition to the palm or finger is placed on at least one base sheet.

The fifteenth invention is a manufacturing method for sheath-shaped application implement according to any one of the eleventh through fourteenth inventions, characterized in that the aforementioned steps in (i) to (iii) are performed in parallel and the obtained two sheets are overlaid on top of each other with the protective films facing the outer side and then sealed in the aforementioned second sealing step, after which another step is provided to cut the sheet assembly to a desired amount to be used.

### Effects of the Invention

A sheath-shaped application implement conforming to the present invention is a sheath-shaped application implement having an empty area in which to insert the palm or fingers formed in the implement, and where the application composition is protected in a manner not contacting the outside until use, but when the application implement is used the protective film can be easily peeled off before or after putting the palm or fingers in position, so that application operation can be performed easily without dirtying the fingers. Accordingly, the application composition can also be evenly placed on the base sheet without using any special, complex device even when multiple high-viscosity application compositions are used, the result of which shows a dramatically increase in the scope of selection of application compositions and an ability to combine different types of application compositions.

The primary feature of a sheath-shaped application implement conforming to the present invention is that even a high-viscosity application composition can be evenly placed on the base without using any special, complex device, which dramatically increases the selection flexibility of application compositions.

In addition, a sheath-shaped application implement conforming to the present invention allows an application composition to be placed on one side or on both sides, and when both sides are used it is possible to combine multiple application compositions, preferably those having different constitutions or performances.

As explained above, a sheath-shaped application implement conforming to the present invention allows the application composition placed on the retention layer of the base sheet to be completely shielded from the outside by the protective film and sealed part on the outside, and by the barrier layer on the inside (side contacted by the palm or fingers), and accordingly, the application composition can maintain its preservation stability and quality retention property without degrading or denaturing during storage. Despite having a simple composition, this sheath-shaped application implement provides significant effects such as meeting, the strict quality assurance requirements for skin preparations for external use, satisfying the diverse needs of users by allowing them to select desired preparations for external use as well as desired bases, providing greater convenience, allowing for easy quality control during manufacturing, and being economical.

A sheath-shaped application implement conforming to the present invention is also constituted by a base sheet that in turn comprises, sequentially from the outside (side used), a protective film, a retention layer on which an application composition is provided, and a barrier layer, where the barrier layer contributes to the prevention of permeation or leakage of the application composition. Although the protective film is peeled off when the application implement is used, the empty area in which to insert the palm or fingers is thin and limited to the thickness of the material sheet, which suppresses the bulkiness of the overall structure and thus the application implement remains compact and offers excellent ease of carrying around.

In addition, a sheath-shaped application implement conforming to the present invention is used in such a way that the protective film on the outside is removed via a simple operation, before or after inserting the palm or fingers, along the sealed parts provided roughly around the outer periphery, after which the palm or fingers are inserted in the sheath-shaped empty area to apply or rub the application composition impregnated in the retention layer onto or into the skin, or perform other applicable operation. The application implement does not dirty the hand or clothes, offers excellent ease of handling and convenience, can be used at any time in any place. Particularly, this application implement is suitable for carrying around in bags, handbags, pouches, etc.

In another embodiment of the present invention, multiple application compositions can be used and it is possible, for example, to provide two or more compartmentalized chambers between the base sheet and protective film and place the same application composition or two or more different types of application compositions in these multiple compartmentalized chambers, respectively.

A sheath-shaped application implement conforming to the present invention is an embodiment of an application implement having a simple structure yet allowing a simple, convenient mixing operation at the time of use, because until the application implement is used the different application compositions can be stored and retained in the compartments provided between the base sheet and protective film in a manner not mixing with each other. When the application implement is used, the protective film is peeled off with a single, quick operation and the application compositions are mixed and the mixture is applied simultaneously to the desired locations of the body.

Even when multiple reactive substances or unstable substances are stored as constituents of an application composition, their quality can be kept stable before use and when the application implement is used the chemical activity or pharmacological activity of the constituents of the application composition can be effectively utilized.

### BRIEF EXPLANATION OF THE DRAWINGS

FIG. 1 Drawing illustrating an example of how a sheath-shaped application implement common to prior arts and the present invention is used

FIG. 2 Schematic cross-section drawing of a conventional sheath-shaped application implement

FIG. 3 Perspective schematic plan drawing of a sheath-shaped application implement conforming to the present invention

FIG. 4 Schematic cross-section drawing of a sheath-shaped application implement conforming to the present invention, viewed from the direction of inserting the palm or fingers

FIG. 5 Different example of FIG. 4

FIG. 6 Schematic cross-section drawing of section B-B′ of the sheath-shaped application implement shown in FIG. 3, viewed from the direction perpendicular to the direction of inserting the palm or fingers

FIG. 7 Different example of FIG. 6

FIG. 8 Schematic drawing illustrating how the protective film is separated

FIG. 9 Schematic cross-section drawing illustrating how the palm or fingers are inserted when the application implement is used (before separation of protective film)

FIG. 10 Different example of FIG. 9

FIG. 11(a) Drawing illustrating the condition of use after separation of protective film, and (b) another drawing illustrating the condition of use after separation of protective film (different example)

FIG. 12 Schematic drawing illustrating a manufacturing process (manufacturing method 1) for a sheath-shaped application implement conforming to the present invention

FIG. 13 Schematic drawing illustrating another manufacturing process (manufacturing method 2) for a sheath-shaped application implement conforming to the present invention

FIG. 14 Perspective schematic plan drawing illustrating the condition of a sheath-shaped application implement after the first sealing in the manufacturing process

FIG. 15 Schematic cross-section drawing illustrating the condition of section A-A′ in FIG. 14 after the first sealing

FIG. 16 Perspective schematic plan drawing illustrating the condition after the second sealing (before cutting) (only one side is shown)

FIG. 17 Schematic cross-section drawing illustrating the conditions of section A-A′ in FIG. 16 after the first sealing and second sealing (only a half of one side is shown relative to the empty area in which to insert the hand or fingers)

### DESCRIPTION OF THE SYMBOLS

1 Conventional application implement used for applying application composition
2 Barrier layer on a conventional application implement
3 Application composition impregnation layer
4 Application composition
5 Outer package
6 Sealed area
7 Cutting line
10 Base sheet
10′ Base sheet
11 Sheath-shaped application implement
12 Protective film
12′ Protective film
13 Heat sealed part
13′ Heat sealed part closer to the hand (separated at the time of use)
13″ Heat sealed part closer to the hand (separated at the time of use)
14 Heat sealed part at tip
141 Heat sealed part at tip (separated at the time of use)
142 Heat sealed part at tip (separated at the time of use)
15 Application composition
15′ Application composition
15″ Application composition
15″′ Application composition
16 Retention layer
16′ Retention layer
17 Barrier layer
17′ Barrier layer
18 Empty area in which to insert the palm or fingers
19 Heat sealed part
20 Line to be cut off
201, 201′ First feed roll
202, 202′ Base sheet
203, 203′ Application composition discharge nozzle
204, 204′ Second feed roll
205, 205′ Protective film
206 Heat sealed part
207 Cut part
21 First sealed part
22 Second sealed part
301 First feed roll
301′ First feed roll
302 Base sheet
302′ Base sheet
303 Discharge nozzle
303′ Discharge nozzle
304 Second feed roll
304′ Second feed roll
305 Protective film
305′ Protective film
3061 First seal welder device
3061′ First seal welder device
3062 Second seal welder device
307 Cutting device

### BEST MODE FOR CARRYING OUT THE PRESENT INVENTION

A sheath-shaped application implement conforming to the present invention is explained using drawings. It should be noted, however, that the present invention is not at all limited to these illustrations.

(Overall Description of Drawings)

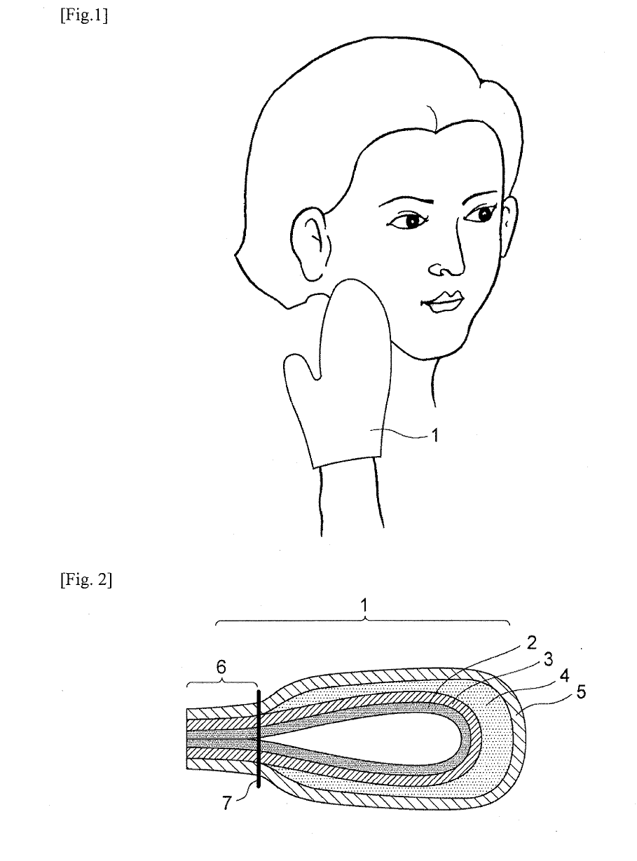

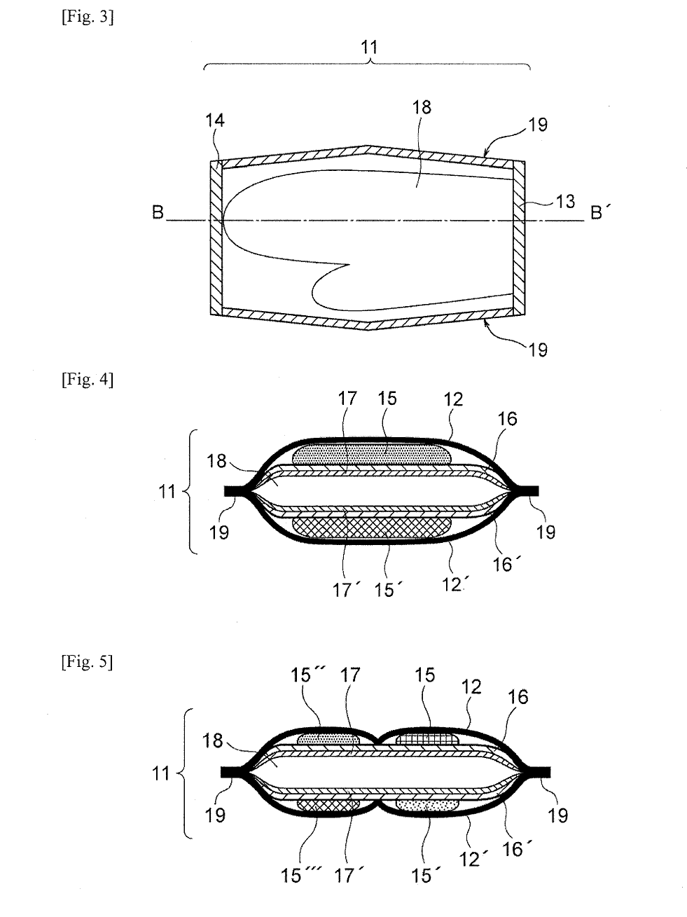

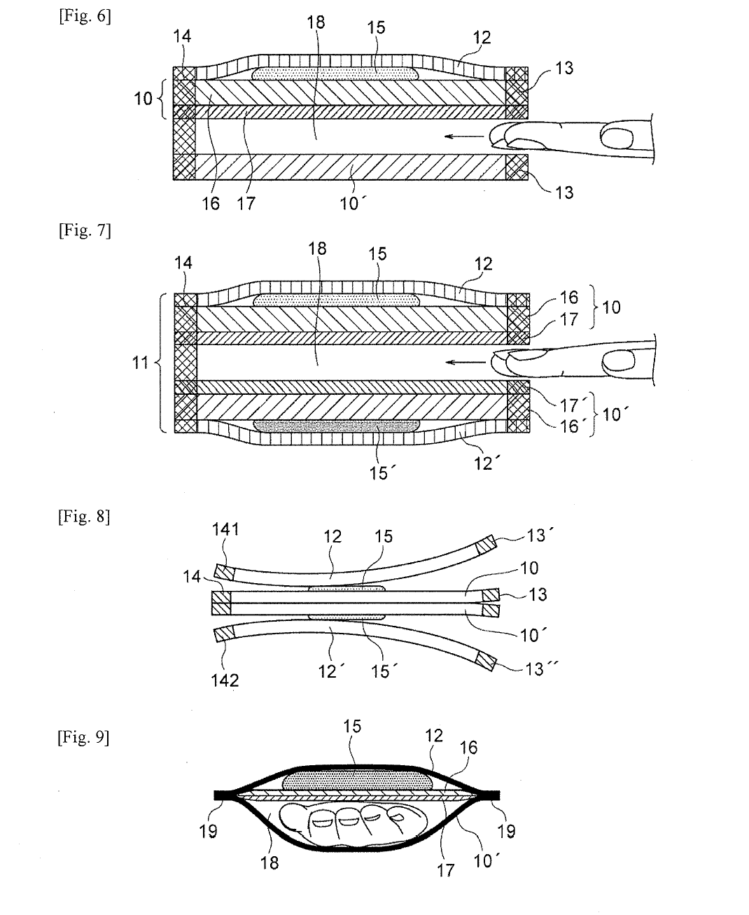

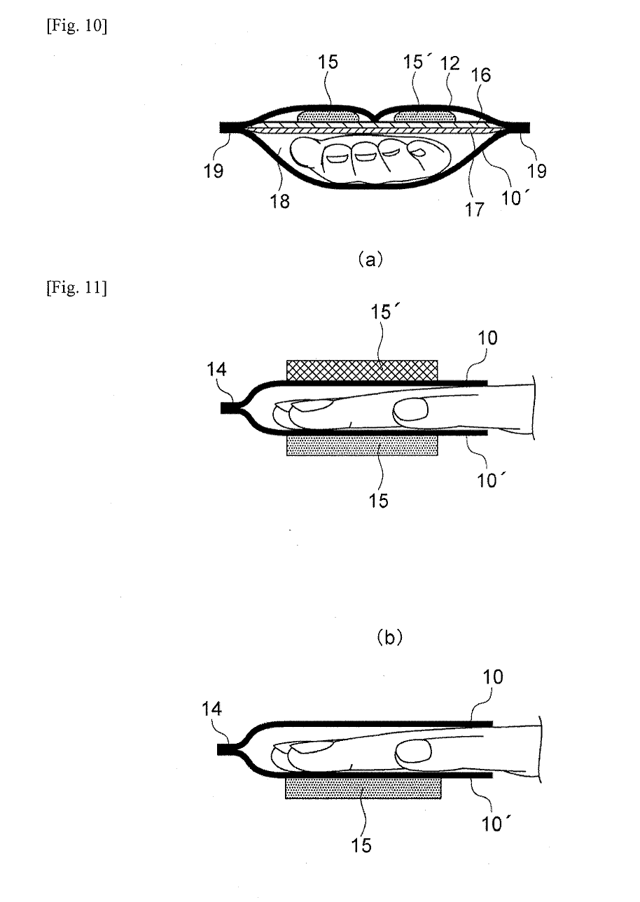

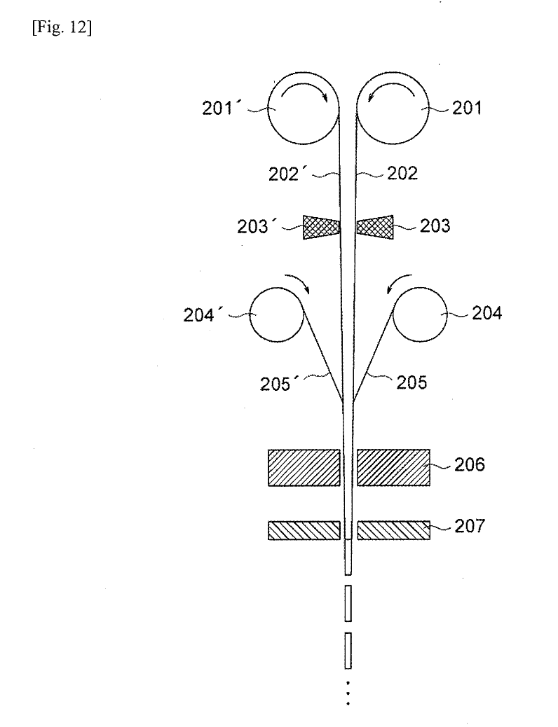

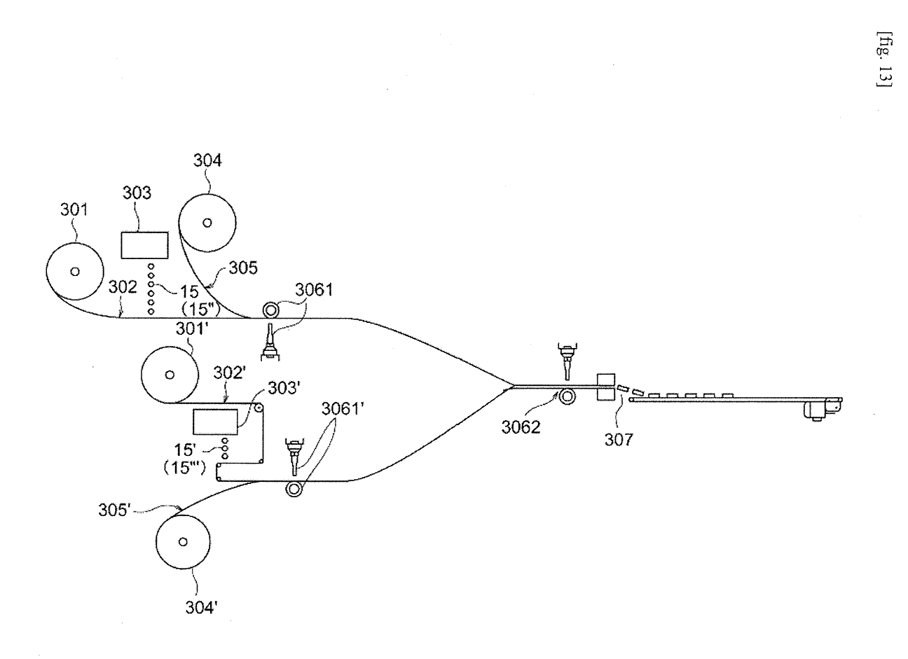

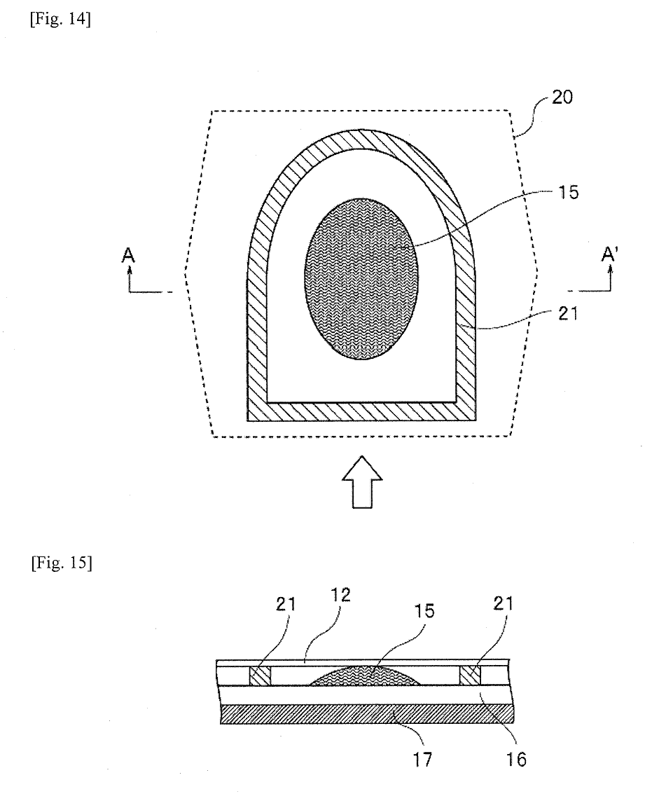

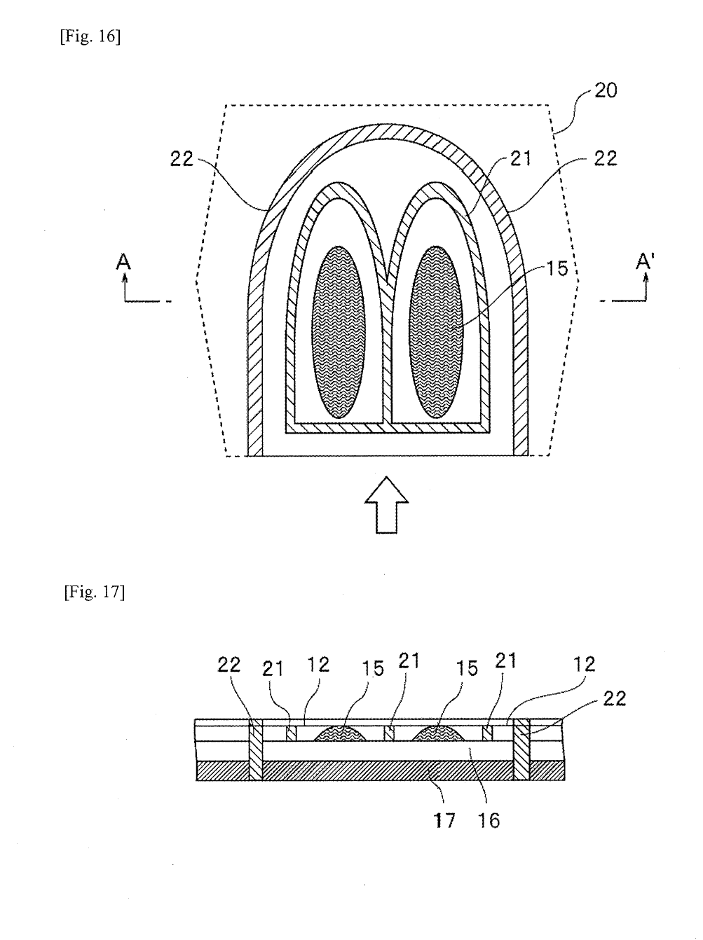

FIG. 1 is a drawing illustrating how a sheath-shaped application implement common to prior arts and the present invention is used. FIG. 2 is a schematic cross-section drawing of a sheath-shaped application implement conforming to prior arts (Japanese Patent Laid-open No. 2003-180449 and Japanese Translation of PCT Patent Application No. 2005-511443) viewed in the lengthwise direction (in the direction perpendicular to the direction of inserting the palm or fingers). FIG. 3 is a perspective schematic plan drawing of a sheath-shaped application implement conforming to the present invention. FIG. 4 is a schematic cross-section drawing of a sheath-shaped application implement conforming to the present invention, viewed from the direction of inserting the palm or fingers. FIG. 5 is a different example of FIG. 4. FIG. 6 is a schematic cross-section drawing of section B-B′ in FIG. 3, viewed from the direction perpendicular to the direction of inserting the palm or fingers. FIG. 7 is a different example (same as above) of FIG. 6. FIG. 8 is a schematic cross-section drawing illustrating how the protective film is removed, viewed from the direction perpendicular to the direction of inserting the palm or fingers. FIG. 9 is a schematic cross-section drawing of a condition of use, viewed from the direction of inserting the palm or fingers. FIG. 10 is a different example of FIG. 9. FIG. 11(a) is a schematic drawing illustrating the condition of use (double-sided type), while FIG. 11(b) is a different example illustrating the condition of use (single-sided type). FIG. 12 is a schematic drawing illustrating a manufacturing process (manufacturing method 1) for a sheath-shaped application implement conforming to the present invention. FIG. 13 is a schematic drawing illustrating another manufacturing process (manufacturing method 2) for a sheath-shaped application implement conforming to the present invention. FIGS. 14 and 16 are perspective schematic plan drawings illustrating the conditions of a sheath-shaped application implement in the manufacturing process. FIGS. 15 and 17 are schematic cross-section drawings illustrating section A-A′ in FIG. 14 and section A-A′ in FIG. 16, respectively.

For your information, all drawings used to explain the present invention are those of a sheath-shaped application implement used by inserting the palm in it. However, these drawings shall also cover embodiments where a sheath-shaped application implement is used by inserting the fingers in it.

FIG. 1 illustrates an embodiment of use common to the aforementioned prior arts and the present invention, where an application composition such as a cosmetic material is applied by inserting the palm or fingers in the sheath-shaped bag 1 of the sheath-shaped application implement.

As shown in the schematic cross-section drawing in FIG. 2, the conventional sheath-shaped bag 1 comprising an air/liquid impermeable layer 2 and a cosmetic material impregnation layer 3 placed on the outer surface of the air/liquid impermeable layer, where a sealed area 6 is heat-sealed after an appropriate amount of a liquid cosmetic material 4 is filled in the space between the cosmetic material impregnation layer and an outer skin layer 5.

When the application implement is used, the package material and base sheet are simultaneously separated along the cutting line 7 provided in the sealed area 6 and thus opened, after which the base material is removed from the package material and the palm is inserted into the center part (indicated by the white section at the center in FIG. 2) to apply, by operating the palm, the liquid cosmetic material impregnated in the impregnation layer 3.

In this case, if the liquid cosmetic material has high viscosity it often becomes difficult to evenly impregnate the liquid cosmetic material in the base sheet. If the viscosity of the cosmetic material is low, on the other hand, the liquid would often leak to the surrounding areas when the package is opened, in which case the areas that come in contact with the liquid become dirty. Accordingly, a sheath-shaped application implement conforming to the present invention is designed to improve the drawbacks of conventional sheath-shaped application implements as explained below.

A sheath-shaped application implement conforming to the present invention is actually placed in a package bag (not illustrated) while it is stored and distributed. An example of such product is shown in FIG. 3. This sheath-shaped application implement product 11 basically comprises a base sheet and a protective film, with an application composition stored in a closed area formed by the first sealed parts 13 (closer to the hand), 14 (closer to the tip), and 19 (side). Formed on the inside (side contacted by the hand or fingers) is an empty area 18 in which to insert the hand or fingers. To insert the hand or fingers, the second sealing does not seal (non-sealed part) the location through which to insert the hand or fingers, so that this location remains an open area. In the second sealing process, welding and melting may be performed in a single step.

A basic layout of application composition is such that an application composition 15 is placed on the base sheet 10 (or on the surface of the retention layer 16 to be specific), where the application composition is protected and stored by the protective film.

There are also embodiments where an application composition 15 is placed only on one side as shown in FIG. 6, where different types of application compositions are placed on both sides as shown in FIG. 4, or where two types of application compositions are placed on each side, respectively, as shown in FIG. 5 (a total of four types of application compositions 15, 15′, 15″, 15″′ are provided). In all cases, when the application implement is used the protective film 12 (12′) is peeled off and the application composition 15 (as well as 15′, 15″ and 15″′ depending on the embodiment) is exposed and used.

As for the type where an application composition is placed only on one side, as shown in FIG. 6, its conditions of use are shown in FIG. 9 (drawing of a condition of use), FIG. 10 (drawing of a condition of use) and FIG. 11(b). As for the type where application compositions are placed on both sides, as shown in FIGS. 4, 5 and 7, its condition of use is shown in FIG. 11(a) (at the time of use).

For your information, the embodiments shown in FIGS. 9 and 10 require that the protective film 12 (12′) be peeled off along the sealed parts provided roughly around the outer periphery.

As for the type where an application composition is placed only on one side, as shown in FIG. 6, the base sheet 10 comprises a barrier layer 17 and a retention layer 16, and the application composition 15 is placed on the surface of the retention layer. The protective film 12 is placed on top to prevent permeation or leakage of the application composition, and sealed by the heat sealed part at tip 14, heat sealed part closer to hand 13, and ends on both sides 19. At this time, the empty area 18 for inserting the palm or fingers is formed between a base sheet 10 and another base sheet 10′, where the entire sheets comprising the application implement must be sealed, except for the opening through which to insert the palm and fingers.

When the application implement is used, the protective film 12 on one side is peeled off along the sealed parts, in the same manner as in FIG. 8 (double-sided type), after which the palm or fingers are inserted into the empty area 18 formed between the base sheets so as to use the application composition 15 on the retention layer 16.

A barrier layer 17 is provided on the back side or inside (side contacted by the palm or fingers) of the retention layer 16 on which the application composition 15 is placed, to eliminate the possibility of the palm or fingers dirtied as a result of the application composition permeating or leaking to the empty area in which to insert the palm or fingers.

Also, the tip of the sheath-shaped application implement (closer to the palm or fingers) and both sides (closer to the palm or fingers) are heat sealed by 14 and 19 roughly around the outer periphery, except for the opening through which to insert the palm or fingers.

In another embodiment, a laminated sheet can be used as the base sheet on one side, while a different sheet material can be used on the other side, as shown in FIG. 6.

In this case, the different sheet material does not come in contact with the application composition, and thus there is no concern over possible permeation or leakage of the application composition. As long as the sheet material has sufficient strength, it is not specifically limited and any sheet can be selected as deemed appropriate.

A sheath-shaped application implement conforming to the present invention is explained based on the double-sided type illustrated in FIGS. 4 and 5. An empty area 18 for inserting the palm or fingers is provided and a barrier layer 17 (17′) is provide on the inside (side contacted by the palm or fingers), after which a retention layer 16 (16′), an application composition 15 (15′), and a protective film 12 (12′) for protecting the aforementioned application composition, are provided toward the outer side. Except for the palm insertion part, these components are sealed (via the second sealing) roughly around their outer peripheries.

For your information, when a sheath-shaped application implement of double-sided layout type, like the one shown in FIGS. 4 and 5, is used, the protective film 12 (12′) is peeled off in the heat sealed parts closer to hand 13′, 13″ and sealed parts at tip 141, 142, in order to effectively peel off the protective film 12 (12′) covering the outside of the application composition retention layer 16 (16′) along the sealed parts provided roughly around the outer periphery, so that the application composition 15 (15′) is exposed to the surface, as shown in FIG. 8. Then, the palm or fingers are inserted in the empty area 18 formed by the remaining base sheet 10 (10′) to operate the application implement in a coating or rubbing motion.

Next, as shown in FIG. 11(a) the application composition 15 on one side is applied to a desired location of the body to apply the application composition, while the application composition 15′ on the other side is also applied to a desired location of the body to apply the application composition.

The application compositions 15 (15′) may be the same composition or different compositions. Needless to say, one type of application composition can be used on one side, as shown in FIG. 11(b).

It is also possible to design the application implement by using base sheets of different materials and characteristics to form retention layers according to the types of application compositions.

If multiple application compositions are used, then regardless of whether the application implement is of single-sided type or double-sided type it is normally desirable to provide the initial sealed parts (first sealed parts), provided to independently store different types of application compositions, roughly along the entire periphery of the area where the application composition is present on the retention layer of the base sheet, or to the outside of this area. This way, the aforementioned composition can be sealed in a manner preventing scattering and loss. If the application composition is a substance that does not easily scatter and get lost, the sealed parts can also be provided slightly on the inside of the area where the composition is present.

Favorable embodiments of manufacturing a sheath-shaped application implement conforming to the present invention are explained below according to the continuous production flows illustrated in FIGS. 12 and 13.

(Manufacturing Method 1)

Manufacturing method 1 is a manufacturing process for a sheath-shaped application implement storing application compositions on both sides of the base sheet (two types of application compositions are stored). As shown in FIG. 12, the first base sheet 202 constituted by a fiber sheet integrally laminated with a resin sheet is set on the first feed roll 201, while the second base sheet 202 constituted by a fiber sheet integrally laminated with a resin sheet is set on the second feed roll 201′, in such a way that the barrier layer faces the inside (side contacted by the palm and fingers) on both rolls, as shown in FIG. 12.

For your information, a resin sheet constituting the barrier layer is placed on the back side (side contacted by the palm or fingers) of the retention layer of the base sheet on which the application composition is placed, in order to prevent permeation of the application composition.

For example, when application compositions are placed on both sides the application compositions can be discharged from respective discharge nozzles 203, 203′. For example, from one nozzle a cleansing cream (viscosity: 1.2 Pa-sec) can be discharged onto the retention layer side of the base sheet 202, while a skin care milk blended with moisture-keeping agent (viscosity: 0.12 Pa-sec), as a different application composition, can be discharged from the other nozzle onto the retention layer side of the base sheet 202′.

Next, the second feed rolls 204, 204′ on both sides are used to roll out a protective film constituted by polyethylene, and the protective film is overlaid on top of the above application compositions to cover the compositions, after which an ultrasonic heat sealing machine 206 is used to seal the peripheries, except for the insertion opening, in such a way that the palm insertion area is shaped like a mitten. Thereafter, the sealed structure is cut to a specified length using a cutting device 207 to obtain a sheath-shaped application implement conforming to the present invention.

The cleansing cream is placed in stripes on the first sheet side of the obtained sheath-shaped application implement, while the skin care milk is impregnated in a uniform manner into the retention layer on the second sheet side.

For your information, while the apparatus shown in FIG. 12 is vertically oriented, a laterally oriented apparatus can also be used to manufacture a similar sheath-shaped application implement by changing the recipes of application compositions, among others.

(Manufacturing Method 2)

A manufacturing process for an application implement, having two chambers on both sides of the base sheet so that multiple types of application compositions are stored in the respective chambers (a total of four types of application compositions are stored), is explained using FIG. 13.

The first base sheet 302 constituted by a fiber sheet integrally laminated with a resin sheet is rolled out from the first feed roll 301, while two types of application compositions 15, 15″ are discharged from discharge nozzles 303 providing application composition discharge outlets arranged in parallel, where each of these two types of application compositions is placed on a fiber sheet constituting the retention layer. A resin sheet constituting the barrier layer is placed on the back side (side contacted by the palm or fingers) of the retention layer of the base sheet 302 on which the application compositions are provided, in order to prevent permeation of the application compositions.

Next, a protective film 305 is rolled out from the second feed roll 304 and overlaid on top of the aforementioned two types of application compositions so that the compositions are covered, and then the first seal welder 3061 is used to heat-seal the protective film so that the two types of application compositions are stored independently (first sealing).

A single nozzle may be used instead of the aforementioned parallel discharge nozzles 303, or only one of the parallel nozzles may be used, if only one type of application composition is used. It is also possible to link the discharge ports with an oscillation device which is controlled in such a way that the application composition can be provided along a zigzag line on the sheet surface. The application composition can be provided in any geometrical shape such as a stripe, lattice, zigzag or plain surface pattern.

A base sheet 302′ (constituted by a fiber sheet integrally laminated with a resin sheet) is rolled out from the first feed roll 301′ separately and in parallel, to discharge two types of application compositions 15′, 15″′ from the parallel discharge nozzles 303′ having two discharge ports, in order to place the two types of application compositions on a fiber sheet corresponding to the retention layer. The aforementioned application compositions 15, 15″, 15′, 15″′ may be the same or different as deemed appropriate.

A resin sheet constituting the barrier layer is placed on the back side or inside (side contacted by the palm or fingers) of the retention layer of the aforementioned base sheet on which the application compositions are placed, in order to prevent permeation or leakage of application composition.

Next, a protective film 305′ is rolled out from the second feed roll 304′ and overlaid on top of the aforementioned two types of application compositions so that the compositions are covered, and the first seal welder 3061′ is used to heat-seal the protective film so that the two types of application compositions are stored independently (first sealing).

Furthermore, each sealed sheet is heat-sealed by the welder device 3062 in a manner allowing the base sheets 302, 302′ to be overlaid on top of each other with the barrier layers (not illustrated) facing the inside (second sealing), after which the sealed structure is cut to a specified dimension using the cutting device 307.

A different example of manufacturing method 2 described above is also explained.

A laminated base material sheet is rolled out from the first feed roll in the same manner as explained above, and two types of application compositions are placed, after which a protective film is laminated on top and then the first heat sealing is performed to form closed compartmentalized chambers.

A different base sheet is rolled out from the first feed roll on the other side, and this time a protective film is placed on top without placing any application composition and the second heat sealing is performed.

This way, two types of application compositions 15 are placed only on one side of the application implement, and also an application implement of a structure where the aforementioned compositions are isolated from each other can be obtained. In this process, the locations enclosed by the first sealed parts are all sealed to create closed areas, because then the application compositions placed in the closed areas between the protective film and base sheet can be covered to prevent leakage or scattering to the outside and consequent loss.

The parts where the aforementioned protective film and base sheet are sealed together (second sealed parts) should desirably be provided in a manner surrounding the outside of the first sealed parts.

Here, as shown in FIGS. 14 to 16, the parts where the protective film 12 heat-sealed together with the base sheet 11 having the application-composition 15's retention layer 16 and barrier layer 17 corresponds to the first sealed part 21. Especially when the retention layer comprises a fiber sheet, the sealed parts are where the fiber and film are heat-sealed together. In the case of weak seal (the sealing force is weak), therefore, a complete welding state where both sheet materials have melted and fused with each other is not achieved and thus the protective film can be peeled off easily.

Also, the second sealed parts 22 are sealed in a nearly open-loop shape in plan view roughly around the outer peripheries of the protective film 12/base sheet 10/base sheet (only when an application composition is provided on one side) and protective film 12/base sheet 10/base sheet 10′/protective film 12 (when an application composition is provided on both sides). The sheet materials constituting the application implement are sealed roughly over their entirety in the thickness direction. Since the barrier layer 17 (17′) positioned on the inside (side contacted by the palm or fingers) of the base sheet 10 achieves a strong surface adhesion, the seal strength becomes higher than the strength of the first sealed parts. This virtually eliminates the concern over possible separation when the palm or fingers are inserted.

As shown in FIGS. 14 to 16, the second sealed parts may roughly correspond to the first sealed parts, except for the palm or finger insertion part (indicated by the arrow). Both the first sealed parts and second sealed parts should desirably be formed along a line or in a strip. The geometrical shapes of the first sealed parts and second sealed parts can be designed in any way desired to the extent that the purpose of the present invention is not compromised. It is important that the first sealed parts are sealed in a manner forming a closed area, while the second sealed part are sealed in such a way as to not seal the location of the opening through which to insert the palm or fingers (this location is called the “non-sealed part”) so that an open area is formed here.

Another embodiment of a sheath-shaped application implement conforming to the present invention is such that two base sheets, each constituted by a retention layer laminated with a barrier layer, are sealed in a manner facing each other, except for the opening through which to insert the palm or finger, or one side is sealed using the aforementioned laminated sheet while the other side is sealed using a different sheet material, as shown in FIG. 6.

The materials for the above sheets are not specifically limited and any sheets can be used. However, it is desirable to seal barrier layers together, each constituted by a resin sheet, because then surface adhesion can be achieved and the seal strength increases.

As for the base material used to place an application composition on top, a laminated sheet material constituted by an application-composition retention layer and a barrier layer must be used. The aforementioned retention layer refers to a layer provided to retain the application composition on the surface and/or inside, where a layer having slight permeation property is advantageous in order to achieve desired retention performance while at the same time the presence of this barrier layer can cut off any direct contact between the application composition and the palm or fingers.

Among others, fiber sheets and sponge sheets are particularly desirable for use as the retention layer in order to achieve greater ease of manufacture, greater ease of use, and desirable touch on skin. These sheets can also be combined together.

If different types of application compositions are used, the sealing to isolate each application composition can be achieved by sealing the protective film and base sheet (first sealing). Normally the first sealed parts should be provided roughly around the circumference of the area where the application composition is present on the retention layer of the base sheet, or to the outside of this area. This way, the aforementioned composition can be sealed in a manner preventing scattering and loss. If the application composition is a substance that does not easily scatter and get lost, the sealed parts can also be provided slightly on the inside of the area where the composition is present.

The aforementioned retention layer and barrier layer may be sealed over their entire surface or at specific points. From the viewpoints of ease of use and durability, it is desirable to use a laminated sheet constituted by a retention layer and a barrier layer. Presence of the barrier layer eliminates the concern over possible direct contact between the palm or fingers inserted into the empty area 18 on one hand, and the application composition on the other.

As for the seal strength, from the viewpoints of retention of quality and practical utility, the peel strength (conforming to JIS Z 0238) between the protective film and fiber sheet in the first sealed parts should preferably be in a range of approx. 0.1 to 5 N/15 mm, while the peel strength (conforming to JIS Z 0238) between the barrier layers in the second sealed parts should preferably be in a range of approx. 10 to 50 N/15 mm.

The barrier layer is provided to prevent the application composition from permeating or leaking to the palm or finger side of the retention layer, and for this purpose a liquid impermeable film is adhered or laminated onto the aforementioned retention layer sheet, or a film-forming material is laminated as a resin sheet using melt coating or other means. Alternatively, a solution of a membrane-growing substance may be coated onto the retention layer to provide a resin sheet.

Any resin sheet material used as this barrier layer must be inactive to and insoluble in the applicable application composition. For example, polyolefin, polyamide, polyester, polyurethane, natural rubbers, synthetic rubbers, etc., can be used alone or in combination.

It is also possible to use alone, or in combination with any of the aforementioned resins, such materials as: polylactic acid, polycaprolactone, ester polyphthalate, polyhydroxy butylate-polyhydroxy valerate copolymer and other aliphatic polyesters; polybutylene adipate-terephthalate copolymer and other aliphatic/aromatic polyesters; celluloses, cellulose-chitosan mixtures and other biodegradable materials.

Specific materials that can be used to form a retention layer over the entire surface of the base sheet for the purpose of placing an application composition include: woven fabrics, knit fabrics, non-woven fabrics and other fiber sheets; papers and synthetic papers; and sponge sheets having a porous structure. Among these, fiber sheets and sponge sheets are particularly desirable in order to achieve greater ease of manufacture, greater ease of use and desirable touch on skin. Materials that are inactive to and insoluble in the applicable application composition are appropriate. For example, polyolefin, polyamide, polyester, polyurethane, natural rubbers, synthetic rubbers, etc., can be used alone or in combination.

It is also possible to use alone, or in combination with any of the aforementioned resins, such materials as polylactic acid, polycaprolactone, aliphatic polyester, bacteria-derived poly 3-hydroxy alkanate, polyamino acid, polyvinyl alcohol, pullulan, celluloses, cellulose-chitosan mixtures and other biodegradable materials.

The weight per area and density of the aforementioned retention layer are not specifically limited, and they should be designed as deemed appropriate so that the application composition can be retained. If the application composition placed on the retention layer is a liquid of low viscosity, the application composition permeates and leaks into the retention layer. If the composition is a gel, cream, paste or other substance of high viscosity, on the other hand, the composition does not permeate much and thus a majority of the composition is retained near the surface of the retention layer.

Also, while the application composition can be placed in any geometrical shape on the retention layer, it is desirable to place the application composition in a specified pattern such as a line, lattice or surface pattern. If the application composition is to be placed in a surface pattern, it can be placed roughly over the entire surface or in certain areas only. In the case of a line pattern, the application composition can be placed in straight lines, curves or any other shapes, but it is possible to place the application composition in straight parallel lines like stripes in these manufacturing processes where the application composition is discharged from parallel nozzles. In this case, the application composition can also be pressured and spread over the surface in a subsequent pressurization process.

One or more types of application compositions can be placed on the retention layer of the base sheet. If combined functions are expected, placement of different types of compositions is desired.

If both sides of the application implement are used to apply cosmetics, protective films and retention layers can be designed with different colors or printing or other decorative means can be applied to identify one side from the other side.

As for the sheet material constituting the retention layer, any sheet material can be selected as deemed appropriate according to the properties and purpose of use of the application composition to be used. For example, assume an application implement where a skin cleansing preparation for external use is placed on one side, while a skin care preparation for external use is placed on the other side. In this case, a sheet offering high abrasion effect can be selected for the retention layer on the cleansing side, while a sheet that is soft to touch can be selected for the skin care side.

The application compositions that can be used are not specifically limited, but skin medicines, quasi-drugs, skin preparations for external use and cosmetic materials can be used favorably. Application compositions having different properties such as powder as well as liquid, cream, paste and gel of various viscosities can be selected.

If the application composition is in a powder form, powder or granule with an average grain size of approx. 0.1 μm to 3 mm can be used favorably when the retention property at the retention layer is considered.

According to a sheath-shaped application implement having a structure conforming to the present invention, even liquid compositions with low viscosities of 1 mPa-sec to 0.5 Pa-sec, or even lower, can be used favorably. On the other hand, high-viscosity compositions that were traditionally difficult to evenly retain on the base material can now be evenly placed on the retention layer, in that sense the present invention provides a significant benefit. Specific viscosities of such high-viscosity compositions should desirably be in a range of 0.5 to 200 Pa-sec at normal temperature, or more preferably in a range of 1 to 100 Pa-sec. Under conventional methods, compositions in these high-viscosity ranges could not be evenly placed on the base material.

If the application composition is a liquid with a low viscosity of 1 mPa-sec to 0.5 Pa-sec, or even lower, it is suitable to use an application implement where the composition is placed on one side without providing separate multiple compartments. If the application composition has high viscosity over 0.5 Pa-sec, on the other hand, it can be used for one or more compartment.

Examples of application compositions that can be used favorably under the present invention include: ointments and gels available as skin preparations and various other skin preparations for external use, preferably skin care cosmetic materials having moisture-keeping effect, whitening effect, anti-inflammatory effect, anti-aging effect or other beneficial effects, cleansing cosmetic materials, peeling agents for external use, gommage cosmetic materials, hair or scalp care preparations for external use, makeup cosmetic materials, foundations, cosmetic materials used for massaging, tanning cosmetic materials, sun care cosmetic materials, deodorizing agents for external use, tonics for external use, cosmetic materials for body care, hair colors, cooling agents, cleansing materials, face wash materials, sun-screening materials, after-sun care preparations for external use, cosmetic materials used as mascara, and so on. According to an application implement conforming to the present invention, these application compositions 15 can be applied to or spread over a specified area of the skin surface, rubbed or massaged into the skin tissues, or used in other appropriate fashion.

When any of the aforementioned various application compositions is applied using an application implement conforming to the present invention, it is possible to use the application implement as a makeup implement, cleansing implement, skin care implement, hair treatment implement, first-aid implement, preparation application implement, sun care implement, self-tanning implement, massaging implement, body or face washing implement, or mascara application implement. Alternatively and preferably, the application implement can be used for multiple purposes selected from among those listed above.

The protective film used under the present invention shields the application composition from drying, oxidation and other external factors of change in order to retain its quality until before use. The protective film is also provided to protect contamination against dust, bacteria and the like. Any material can be used for the protective film without limitation, as long as the material can achieve these required characteristics. However, various thermoplastic resin films are desirable because they can be sealed thermally.

Among others, use of polyolefin, polyamide, polyester or polyurethane film is desirable. Or, it is possible to use alone, or in combination with any of the aforementioned synthetic resins, such materials as polylactic acid, polycaprolactone, aliphatic polyester, bacteria-derived poly 3-hydroxy alkanate, polyamino acid, polyvinyl alcohol, pullulan, celluloses, cellulose-chitosan mixtures and other biodegradable materials.

It is more preferable to use a material containing a biodegradable substance as the material for the base sheet and/or protective film, because such material reduces the environmental load and thus the such application implement can be used as an ecological material friendly to the environment.

Gas barrier materials, each constituted by a film made of such environmentally friendly material and a metal layer or different synthetic resin, can also be used. It is also possible to provide an adhesion layer beforehand on the film surface.

The protective film used under the present invention is sealed on the base sheet for the purpose of preventing the application composition placed on the retention layer from scattering and getting lost until use and also for the purpose of retaining the quality of the application composition. Accordingly, the method and form of seal are not specifically limited, as long as the protective film can be sealed in a removable manner onto the retention layer constituting the material sheet so that the aforementioned protective film can be removed easily along the sealed parts. Preferably, the protective film should be sealed all around by means of thermal welding, thermal press, thermal embossing or other mechanical means based on direct heating external heating, or high-frequency induction heating, high-frequency dielectric heating, internal heating means using microwave or other electromagnetic wave, or internal heating means using ultrasonic wave. In particular, heating machines (welders) utilizing high frequency, microwave and ultrasonic wave can selectively and intensively heat the specified sealing areas, which is convenient because the seal strength can be controlled with ease.

Using the above methods, the protective film can be firmly sealed to retain the quality of the application compositions until the product is used, and when the product is used the protective film can be removed without fail along the sealed parts.

Furthermore when a laminated structure is sealed, it is also possible to selectively seal only a specified layer by selecting the processing time, adjusting the focus, etc. Completing sealing and cutting simultaneously is also possible. The two-dimensional shape of the aforementioned sealed parts may be a line or stripe, and more preferably a tab shape should be formed at, among others, the end of the outer periphery side of the aforementioned seal, because then the peeling operation becomes easier and the protective film can be peeled off reliably along the parts sealed with the base sheet.

When sealing the base sheet and protective film, it is also possible to selectively seal only a specified layer by selecting the processing time, adjusting the focus, etc. Completing sealing and cutting simultaneously is also possible. The two-dimensional shape of the aforementioned sealed parts may be a line or stripe, and more preferably a tab shape should be formed at, among others, the end of the outer periphery side of the aforementioned seal, because then the peeling operation becomes easier and the protective film can be peeled off reliably along the sealed parts.

An application implement conforming to the present invention basically comprises two base sheets, each constituted by a laminated sheet which in turn is constituted by a retention layer 16 (16′) and a barrier layer 17 (17′), and these base sheets are sealed all around, except for the opening through which to insert the palm and fingers, in such a way that the barrier layers face each other on the inside (side contacted by the palm or fingers), in order to create an empty area in which to insert the palm or finger and also prevent the application composition from contacting the palm or finger.

In a different embodiment, a laminated sheet is used as the base sheet on one side, while a different sheet material is used on the other side, as shown in FIG. 6.

Here, the above different sheet material does not come in contact with the application composition and thus there is no concern over possible permeation nor leakage of the application composition. In this sense, the material for this sheet is not specifically limited and any sheet can be used as deemed appropriate as long as it has the specified strength.

If different types of application compositions are used, the sealing to isolate each application composition can be achieved by sealing the protective film and base sheet (first sealed parts). Normally the first sealed parts should be provided roughly around the circumference of the area where the application composition is present on the retention layer of the base sheet, or to the outside of this area. This way, the aforementioned composition can be sealed in a manner preventing scattering and loss. If the application composition is a substance that does not easily scatter and get lost, the sealed parts can also be provided slightly on the inside of the area where the composition is present.

In any of the aforementioned embodiments, the exterior of the sheath-shaped application implement conforming to the present invention can be designed in any geometrical shape such as rectangle, square, parallelogram, trapezoid, oval, circle, cone, etc., in plan view. To form a desired shape, fusing, cutting or other method can be adopted. Heat sealing using a heating means based on high frequency, microwave or ultrasonic wave can be carried out simultaneously with fusion, which is convenient. Under the present invention, it is sufficient that the insertion part has enough size to put the palm or fingers in to apply the application composition onto the skin. Assuming cases where a wide application area of the skin must be covered, it is better to increase the size of the sheath-shaped application implement to increase the effective area. Accordingly, the opening should also have enough size to insert the palm of the hand. If a detailed application operation is required in only a limited location, the size of the insertion part may be reduced to the extent that the fingers can still be inserted. The interior of the insertion part should preferably be formed in a bag, mitten or glove shape because it will provide ease of handling when applying the composition to the skin or spreading it over the skin.

When the application implement is used, the palm or fingers are inserted into the aforementioned empty area provided for insertion and the application implement is gripped, and in this condition the protective film is peeled off to expose the application composition 15 placed on the retention layer of the application base. The exposed application composition is then applied to a desired skin area on the face, neck, shoulder, arm or other part of the body.

For your information, the parts that seal the protective film and base sheet over their entirety (second sealed parts) may be provided in a manner surrounding the outer side of the first sealed parts, or the second sealed parts may be provided on the inside of the first sealed parts. Preferably the second sealed parts should be provided on the outside of the first sealed parts in a manner roughly conforming to the outer periphery of the application implement, because then the area involved in the application operation can be utilized effectively.

Also under the present invention, the sealed parts can also be formed using adhesive. However, heat sealing by a heating means is preferred in terms of productivity. Since the material can be selectively heated in specified areas, a means selected from the group that includes high-frequency heating, microwave heating and ultrasonic heating is preferred. Among those, heat sealing by the ultrasonic oscillation method is the most preferred choice in terms of process controllability and productivity.

If an ultrasonic welder device is used, the oscillation frequency should preferably be in a range of approx. 15 to 40 kHz, among which 20 kHz is more appropriate. The ultrasonic output should preferably in a range of 500 to 5000 W, among which a range of 1000 to 3000 W is more appropriate. The output can be changed between the first sealing and second sealing. For the second sealing, the output should preferably be raised beyond the first sealing output to improve the seal strength, because the material to be sealed is thicker in the second sealed parts.

To achieve the first sealed parts and second sealed parts having specified shapes, an ultrasonic welder device having an oscillation hone movable via computer control can be used. When continuous production is assumed, however, it is preferable to use rollers that serve as receiving dies on the opposite side of the oscillation hone, where the rollers should have a pattern matching the shape and dimensions of the target application implement. As for the line speed and pressure applied to the sheet to be sealed, desired settings can be selected as deemed appropriate according to the type, thickness and density of the material, among others. The ultrasonic oscillation time in the sealing process should preferably be in a range of approx. 0.1 to 5 seconds in consideration of productivity and seal strength.

Under the present invention, it is more desirable that the sealed sheet obtained as explained above be formed to a specified shape and dimensions. Any geometrical forming shape can be selected. The forming method is not specifically limited, and stamping or other mechanical method, laser cutting, water jet cutting or any other desired machining means can be used.

As for the number of compartments, two, three, four or more compartments can be provided. A different substance can be placed in each of these compartmentalized storage parts, but if reactive substances or unstable substances are used, they should be placed in different compartments in an isolated manner so that they are mixed only when used. The isolation method is not specifically limited, and multiple compartments may be formed or partitions may be provided to separate a single compartment, in order to provide independent compartments that do not overlap with one another.

In either way, the step to form the first sealed parts is to seal the protective film and base sheet at the sealed parts, as a result of which an isolated structure described above is set.

If different types of application compositions are stored in different compartments, the application compositions can be mixed only when the protective film is removed. After the protective film has been removed, the application compositions are mixed or kneaded as the retention layer side of the base sheet is used to rub the skin surface or hair, and the homogenized application composition mixture is applied to a desired location as a result. If the application composition contains any unstable substance or reactive substance, the reaction is started only in this stage, which effectively achieves mixing on demand.

### EXAMPLES

An application implement conforming to the present invention is explained below in further detail using the following examples.

### Example 1

(Dual-Purpose Implement for Cleansing and Skin Care)

A meshed non-woven fabric constituted by polyethylene terephthalate (PET) (70 g/m²) was thermally laminated with a polyethylene film (40 μm) to manufacture an application base (sheet A) constituted by a retention layer and a barrier layer.

Also, a non-woven fabric (60 g/m²) obtained by combining PET fiber and polypropylene (PP) fiber (at a PET/PP ratio of 70/30 percent by weight) was thermally laminated with a polyethylene film (30 μm) to manufacture an application base (sheet B) constituted by a retention layer and a barrier layer.

A sheath-shaped application implement conforming to the present invention was manufactured using an apparatus equipped with roll feeder parts, nozzles capable of discharging high-viscosity compositions (the nozzles have many holes through which to discharge composition onto the base material surface in stripes), protective-film feeder parts, heat sealing parts, and cutting part. The application implement was manufactured in the manner explained below.

Sheet A was set on a first feed roll 201, sheet B was set on another first feed roll 201′, and application base sheets 202, 202′ were set by orienting their barrier layers inside. A cleansing cream (viscosity: 1.2 Pa-sec), as an application composition, was discharged from the discharge nozzle 203 on one side onto the retention layer surface of the application base 202, while a different application composition, or specifically a skin care milk blended with moisture-keeping agent (viscosity: 0.12 Pa-sec), was discharged from the discharge nozzle 203′ onto the retention layer surface of the application base 202′. Next, a protective film (80 μm) constituted by polyethylene was rolled out from the second feed rolls 204, 204′ on both sides to laminate the above application compositions in a manner covering the application compositions, after which a heat sealing machine 206 adopting the ultrasonic heating method was used to heat-seal the protective films (by leaving the opening so that the palm insertion area would be shaped like a mitten), and then the sealed structure was cut to a specified length at a cutting part to obtain a sheath-shaped application implement conforming to the present invention. The cleansing cream was placed in stripes on the sheet A side, while the skin care milk was impregnated into the retention layer in a uniform manner on the sheet B side.

The obtained sheath-shaped application implement was kept for 2 months at 50° C. and then used. First, the palm was inserted through the insertion inlet to grip the application implement, and the protective film on the cleansing cream side was peeled off by pulling the film from the tab formed on the insertion inlet side toward the tip along the thin-stripe sealed parts formed along the outer periphery. Because of the selective heat sealing using ultrasonic wave, the film could be removed easily. The content, or cleansing cream, was not subject to denaturing and its quality remained the same as when the cleansing cream was initially filled.

(Use Result)

Because the meshed non-woven fabric was used as the retention layer, the synergistic effect of the cleansing cream and meshed non-woven fabric allowed the makeup cosmetic material to be removed easily from the face by only rubbing the application implement gently over the face. In addition, the application implement was easy to use because the base sheet was flexible, and the implement could be used efficiently and in fine motion even in locations of irregular surface such as around the nose and below the eyes, and the palm did not become tired.

After the cleansing, while still holding the sheath-shaped application implement on the palm the protective film on the sheet B side was peeled off by pulling the film from the insertion inlet side toward the tip. Again, the film could be removed easily along the heat sealed parts. The skin care milk impregnated and retained in the retention layer did not dry up or was subject to denaturing in any way but remained in the same condition as when the skin care milk was initially filled. This skin care milk could be applied onto the cleaned face with ease and the application implement was felt soft on the face. These features ensured an effective aftercare.

As explained above, despite its simple structure the sheath-shaped application implement conforming to the present invention offered an excellent effect in retaining the quality of the cosmetic materials contained in it and was also easy to operate when in use.

By selecting desired application bases and application compositions, only one application implemented could be used provide the cleansing function and skin care function, both of which could be combined to enhance the beautifying effect. In addition, the palm never became dirty in the process of applying these compositions onto the face.

### Example 2

(Hair Treatment Implement)

A non-woven fabric constituted by PET fiber (60 g/m²) was thermally laminated with a polypropylene film (40 μm) to manufacture an application base constituted by a retention layer and a barrier layer.

This base sheet was set on each of the first feed rolls 201, 201′ of the apparatus shown in Example 1 by orienting the barrier layer inside, after which a hair setting gel (viscosity: 74 Pa-sec) was discharged from the nozzle 203 on one side, while a hair tonic mousse (viscosity: 0.84 Pa-sec) was discharged from the nozzle 203′ on the other side, to be placed in stripes on the surfaces of base sheets 202, 202′. Protective films were then laminated and heat sealed (by leaving the opening so that the palm insertion area would be shaped like a glove), after which the sealed structure was cut to manufacture a sheath-shaped application implement conforming to the present invention.

The obtained application implement was further fed through a roll press to uniformly spread the application compositions that had been placed in stripes. As a result, for the first time addition of high-viscosity substance in an even manner became possible, which was totally impossible when using the traditional impregnation method.

The obtained sheath-shaped application implement was kept for 2 months at 50° C. and then used. First, the palm was inserted through the opening to hold the sheath-shaped application implement, and the tab of the protective film on the application base side on which hair tonic was placed was held with fingers and pulled from the opening toward the tip so as to peel off the film. The sealed parts formed roughly in a line shape along the outer periphery were formed using microwave heating, so the film could be peeled off with ease. The content, or hair tonic, did not dry up or was subject to denaturing in any way and its quality remained the same as when the hair tonic was initially filled.

Since the interior of the application implement was formed in a five-finger glove shape, the wearing feel and fitness were excellent and when this application implement was used to massage the hair after washing, the hair tonic could be applied evenly to the hair and scalp, exhibiting superior scalp absorption effect and massaging effect.

Next, this sheath-shaped application implement was worn by the palm on the other hand and the protective film on the hair setting agent side was pulled off in the same manner. The hair setting agent kept its quality and remained the same as when it was originally filled. The application implement was very easy to wear and operate, and even the hard hair setting agent could be applied evenly to the hair, which made the application implement an excellent hair care implement. Even those not familiar with beauty treatment could enjoy an ample treatment benefit by using this application implement conforming to the present invention. Also, the palm was not dirtied at all in the process of treating hair.

### Example 3

(First-aid Implement)

A fabric constituted by PET fiber (60 g/m²) was thermally laminated with a polyurethane film (40 μm) to manufacture an application base constituted by a retention layer and a barrier layer, and then the application base was sterilized.

Using the same apparatus used in Example 1, a sheath-shaped application implement conforming to the present invention was manufactured under sterilization control.

The application base was set on each of the first feed rolls 201, 201′ by orienting the barrier layer inside, and a disinfectant (viscosity: 3 mPa-sec) was discharged from the nozzle 203 on one side to be placed over the entire surface of the base sheet 202, while an ointment paste blended with antimicrobial drug (viscosity: 127 Pa-sec) was discharged from the nozzle 203′ on the other side to be placed onto the surface of 202′ in stripes.

Protective films were then laminated and heat sealed (by leaving the opening so that a bag-shaped empty area of the size of two fingers was formed for inserting the palm or fingers), after which the sealed structure was cut to manufacture a sheath-shaped application implement conforming to the present invention. The obtained application implement was further fed through a roll press to uniformly spread the application composition placed in stripes. As a result, for the first time, addition of high-viscosity substance in an even manner became possible, which was totally impossible when using the traditional impregnation method. On the other hand, the low-viscosity disinfectant was uniformly impregnated into the base through diffusing, permeating and leaking actions.

The obtained sheath-shaped application implement was kept for 2 months at 50° C., after which it was used in a first-aid treatment of wound. First, the application implement was worn on fingers and the protective film on the side of the application base on which the disinfectant was placed was peeled off by pulling the film toward the tip of the fingers. The protective film could be removed easily. Since the content, or disinfectant, was preserved in an air-tight condition, it did not dry up or was not subject to denaturing in any way, and its quality remained the same as when the disinfectant was initially filled. The disinfectant was easily applied by gently tracing on the wound.

Next, the aforementioned sheath-shaped application implement was reversed while the fingers were still inside, and the protective film was peeled off. Both the ointment side and disinfectant side remained in a sterile state until immediately before use. When the sheet surface on which the ointment was attached was used to gently trace the wound, the ointment was transferred onto the wound. The application implement was felt soft at the wound during the treatment and little pain was felt. Due to its great wearing feel, the application implement could be operated in fine motion and even small wounds could be treated with ease.

As explained above, the sheath-shaped application implement conforming to the present invention, despite being a single implement, provided the two functions as a disinfecting implement and a preparation application implement, and its simple structure also made the application implement easy to carry. It was proven a superior first-aid implement that was very convenient, too, because the application implement could be disposed of after use.

### Example 4

(Sun Care Implement)

A NBR (nitrile butadiene rubber) sponge sheet of a foamed structure (thickness: 2 mm) was thermally laminated with a polyurethane film (50 μm) to manufacture an application base constituted by a retention layer and a barrier layer.

The aforementioned application base was set on each of the feed rolls 201, 201′ by orienting the barrier layer inside, and a water-based sun care lotion blended with anti-inflammatory agent and soothing agent (viscosity: 1.2 mPa-sec) was sprayed onto the surface of the base sheet 202, after which a protective film was laminated and heat-sealed (using high frequency by leaving the opening so that the palm insertion area would be shaped like a mitten), after which the sealed structure was cut to manufacture a sheath-shaped application implement used only on one side.

The obtained sheath-shaped application implement was kept for 2 months at 50° C. and then used. First, the palm was inserted through the opening to wear the application implement on the palm, and the protective film was peeled off by pulling it from the tab formed on the opening side toward the tip.

Because the inside was shaped like a mitten, the application implement had good fitness. The retention layer of the base sheet was impregnated with a plenty of water-based lotion, and the lotion could be applied to every corner of the sunburned and flushed face, neck and shoulders by only stroking the application implement over them. The application implement was also very soft to touch and never aggravated the tingling pain resulting from sunburn. Also, this sun care implement could be conveniently used without dirtying the palm, and thus it received very good responses from travelers.

### Example 5

(Preparation Application Implement)

A polyurethane sponge sheet of a fine foamed structure (thickness: 2.5 mm) was thermally laminated with a polyurethane film (30 μm) to manufacture an application base constituted by a retention layer and a barrier layer.

The aforementioned application base was set on one feed roll 201 (by orienting the barrier layer inside), while a polyester non-woven fabric (150 g/m²) was set on the other feed roll 201′, and an eczema treatment gel (viscosity: 193 Pa-sec) was discharged from the nozzle 203 onto the face of the base sheet 202. A protective film was then laminated and heat-sealed (utilizing ultrasonic wave to form a bag-shaped empty area of the size of three fingers for inserting the palm or fingers), after which the sealed structure was cut to manufacture a sheath-shaped application implement used only on one side. By combining a subsequent press process, even the high-viscosity gel could be evenly placed on the surface of the polyurethane sponge base sheet.

After keeping the obtained sheath-shaped application implement for 2 months at 50° C., the gel did not dry up or was not subject to denaturing in any way and its quality remained the same as when the gel was initially filled.

With the sheath-shaped application implement worn on the fingers, the protective film was peeled off. The application implement had excellent cushion property and fitness. By using the aforementioned application implement to gently rub the area, the gel could be selectively applied onto the skin surface, and the added rub-in motion enhanced the absorption of gel into the skin. Because the application base that came in direct contact with the skin was made of a flexible polyurethane sheet, the area was not stressed nor itchiness promoted. Also, the fingers did not become dirty in the application process.

### Example 6

(Self-Tanning Implement)

A non-woven fabric constituted by PET fiber (60 g/m²) was melt-coated with a polyethylene (thickness: 10 μm) to manufacture an application base constituted by a retention layer and a barrier layer.

The aforementioned application base was set on each of the feed rolls 201, 201′ by orienting the barrier layer inside, and a sun tanning paste blended with colorant (viscosity: 36 Pa-sec) was pushed out from the nozzle 203 onto the surface of the base sheet 202 in a lattice pattern, after which a protective film was laminated and heat-sealed (utilizing ultrasonic wave by leaving the opening so that a bag-shaped palm insertion area would be formed), after which the sealed structure was cut to manufacture a sheath-shaped application implement used only on one side.

The obtained sheath-shaped application implement was kept for 2 months at 50° C. and then used.

First, the palm was inserted through the opening to wear the application implement on the palm, and the protective film was peeled off by pulling it from the tab formed on the opening side toward the tip.

Because the inside was shaped like a bag, the application implement provided good fitness for all users regardless of the shape of their palm. The retention layer of the base sheet had enough tanning agent needed for a pseudo tanning treatment, and the flexible base was very easy to use when applying the tanning agent and the agent could be applied and spread in any part of the body in a conveniently manner, even in locations of irregular surface, and the responses from the users were very positive. The tanning agent had high viscosity and thus did not drip during use, and the palm and clothes did not become dirty at all.

Furthermore, manufacturing examples and use examples are explained below based on Examples 7 to 12 and the manufacturing flow illustrated in FIG. 13. Needless to say, the application implements explained in Examples 1 to 6 above can be manufactured using the apparatus conforming to the flow shown in FIG. 13.

### Example 7

(Application Implement for Skin Care Cosmetic Material of Water/Oil-Phase Separation Type)

As the base sheet used on both sides, a laminated sheet constituted by an aliphatic polyester non-woven fabric whose key constituent is polylactic acid fiber (weight per area: 100 g/m²) and a biodegradable polyurethane film (thickness: 20 μm) was used.

A polylactic acid film (thickness: 100 μm) was used as the protective film.

As for the application compositions, two parallel continuous nozzles were used to discharge a cosmetic material composition for water-phase skin care gel from one side, and a cosmetic material composition for oil-phase skin care gel, both onto the non-woven fabric surface of the base sheet in a manner not allowing the two compositions to be mixed together.

According to manufacturing method 2 explained above, an application implement was manufactured that had a mitten-shaped empty area on the inside and a compartmentalized area having two independent compartments only on one side.

This application implement had the water phase and oil phase stored separately until the start of use, and thus it was not necessary to use any surface active agent and there was no concern at all over a possible phase separation even after a long period of storage.

At the time of use, the palm was inserted through the opening provided in this application implement, and then the protective film was peeled off and removed, after which the exposed compositions were mixed together on the face via rubbing action and the mixture was rubbed into the skin. Because the water phase and oil phase were stored separately, no surface active agent was used and after 1 month of this beauty treatment where the treatment was repeated daily, even those with sensitive skin reported an excellent feeling of use and no sensitizing reaction. Because the protective film could be peeled off and removed with ease and the barrier layer was provided on the inside (side contacting the empty area for inserting the palm), the palm did not become dirty during use. Furthermore, the application implement presented an excellent wearing feel and was easy to operate.

### Example 8

(Hair-Coloring Implement Used with Two-liquid Mixing-Type Hair Color)

The same base sheet and protective film explained in Example 7 were used.

As for the application compositions, two parallel continuous nozzles were used to discharge a gel composition containing hair-coloring dye from one side, and a gel composition containing oxidizing agent from the other side, both onto the non-woven fabric surface of the base sheet in a manner not allowing the two compositions to be mixed together.

According to the manufacturing method explained above, an application implement was manufactured that had a glove-shaped empty area on the inside and two independent compartments only on one side (refer to FIG. 10).

This application implement had the dye and oxidizing agent stored separately until the start of use, and thus the activity of the dye did not drop at all even after a long period of storage.

At the time of use, the protective film was peeled off and removed, and the exposed compositions were mixed together on the hair surface via rubbing action to apply the mixture to the hair.

Because the compositions could be mixed during use, the activity level of the dye was high and the hair could be colored efficiently. Also, because the protective film could be peeled off and removed with ease and the barrier layer was provided in the empty area for inserting the palm, the palm did not become dirty during use. Furthermore, the application implement presented an excellent wearing feel and was easy to operate because it was formed in a shape befitting the palm.

### Example 9

(Face-Washing Implement Used with Mixing-Type Face Wash)

As the base sheet used on both sides, a laminated sheet constituted by a polyester (polyethylene terephthalate) non-woven fabric (weight per area: 150 g/m²) and a polyethylene film (thickness: 40 μm) was used.

A polyethylene film (thickness: 150 μm) was used as the protective film.

As the application compositions, a powder constituted by clay powder and silica powder (average grain size: 35 μm) was sprayed onto the non-woven fabric surface, while a composition for face wash gel was also placed, by making sure the two compositions would not mix together on the non-woven fabric surface.

According to the manufacturing method explained above, an application implement was manufactured that had a glove-shaped empty area on the inside and two compartments on one side (refer to FIG. 10).

This application implement had the powder and face wash materials stored separately until the start of use, and thus the undesirable phenomenon where the powder separates from the face wash material due to differential specific gravity between the two did not occur at all even after a long period of storage.

At the time of use, the protective film was peeled off and removed, after which the powder and face wash material compositions were mixed together on the face via rubbing action and the face was massaged using the mixture. Because the compositions were mixed during use as the face was washed, the application implement could remove dead skin cells and clean and massage the face more effectively than when the face was washed using a normal scrub agent. Also, because the protective film could be peeled off and removed with ease and the barrier layer was provided on the inside of the empty area in which to insert the palm, the palm did not become dirty during use. Furthermore, the application implement presented excellent wearing feel and was easy to operate because it was formed in a shape befitting the palm.

### Example 10

(Application Implement Used with Two-liquid Mixing-Type Skin Care Agent)

The base sheets and protective films on both sides were the same as those used in Example 9.

As for the application compositions, a water-based gel composition containing sodium hydrogen carbonate, and a water-based gel composition containing glucoside ascorbate and citric acid, were placed on the non-woven fabric surface of the base sheet in a manner not allowing the two compositions to be mixed together.

According to the manufacturing method explained above, an application implement was manufactured that had a glove-shaped empty area on the inside and two independent compartments on one side (refer to FIG. 10).

This application implement had the sodium hydrogen carbonate powder and citric acid stored separately until the start of use, and thus the two did not react with each other even after a long period of storage.

At the time of use, the protective film was peeled off and removed, after which the compositions were mixed together on the face via rubbing action and the face was massaged using the mixture.

Carbonic acid gas generated immediately when the mixing was started and the face was quickly covered with foam. When this beauty treatment was continued for 1 month, the beautifying complex permeated into the skin more effectively than when carbonic acid gas was not generated, and consequently a high beautifying effect was achieved.

Also, because the protective film could be peeled off and removed with ease and the barrier layer was provided on the inside of the empty area for inserting the palm, the palm did not become dirty during use. Furthermore, the application implement presented an excellent wearing feel and was easy to operate because it was formed in a shape befitting the palm.

### Example 11

(Double-Sided Implement Used with Mixing-Type After-Sun Care Agent)

The base sheets and protective films on both sides were the same as those used in Example 9.

As for the application compositions, a mixed powder constituted by ammonium nitrate and urea, and a water-based gel composition, were placed on one side (side A) of the base sheet in a manner not allowing the two compositions to be mixed together.

Also, a water-based composition containing dipotassium glycyrrhizinate was placed on the other side (side B) of the base sheet.

According to the manufacturing method explained above, an application implement was manufactured that had a structure where a bag-shaped insertion area was provided inside and one side had two compartments while the other side was not divide by partitions.

This application implement separately stored the ammonium nitrate in a dry state until the start of use, and thus endothermic reaction did not occur even after a long period of storage.

At the time of use, the protective film on side A was peeled off and removed, after which the compositions were mixed to initiate the cooling reaction. After the entire application implement had cooled sufficiently, the application implement was placed over the palm and the protective film on side B was peeled off and removed, after which the water-based gel composition containing dipotassium glycyrrhizinate was applied to the sunburned and flushed neck and shoulder via gentle massaging action. The water-based gel composition on side B was very cool and effective in soothing the inflammation. The application implement could be used conveniently for after-sun care following outdoor sports.

Also, because the protective film could be peeled off and removed with ease and the barrier layer was provided on the inside of the empty area for inserting the palm, the palm did not become dirty during use. Furthermore, the application implement presented an excellent wearing feel and was easy to operate because it was formed in a size fitting the palm.

### Example 12

(Double-Sided, Dual-Purpose Application Implement Used with Mixing-Type Gommage/Skin Care Agent)

The base sheets and protective films on both sides were the same as those used in Example 9.

As for the application compositions, a mixing-type gommage cosmetic material constituted by a water-based gel composition containing carboxy vinyl polymer and polyvinyl alcohol, and an oil-based gel composition containing vegetable oil, were placed on one side (side A) of the base sheet in a manner not allowing the two compositions to be mixed together on the non-woven fabric surface of the base sheet.

Also, a vitamin C powder, and a water-based gel composition, were placed on the other side (side B) of the base sheet in a manner not allowing the two compositions to be mixed together.

According to the manufacturing method explained above, an application implement was manufactured that had a structure where a bag-shaped insertion area was provided inside and two independent compartments were provided on both sides (FIG. 5).

This application implement stored the vitamin C in a dry state until the start of use, and thus there was little effect of oxidation and the activity of vitamin C was retained.

At the time of use, first the protective film on side A was peeled off and removed, after which the water-based composition and oil-based composition were mixed together on the face to apply the gommage cosmetic material. Through this operation, dead skin cells and other waste products as well as sebum and dirt could be easily removed without dirtying the palm. Because no surface active agent was needed, even those with sensitive skin reported no irritation and the application implement offered an excellent feeling of use.

Next, this application implement was reversed and the protective film on side B was peeled off and removed, after which the vitamin C and water-based gel composition were mixed together on the face and the mixture was rubbed into the face. Since the mixture was rubbed into the skin through its surface that was now free from dirt and other foreign matters, and also because the activity of vitamin C was retained, the mixture was effectively absorbed percutaneously and a remarkable whitening effect could be achieved.

Also, because the protective film could be peeled off and removed with ease and the barrier layer was provided on the inside of the empty area for inserting the palm, the palm did not become dirty during use. Furthermore, the application implement had an excellent wearing feel because it was formed in a size fitting the palm, and the bag-shaped reversible structure resulted in superior ease of operation.

### Example 13

(Double-Sided, Dual-Purpose Implement for Applying and Removing Mascara)

The same base sheet and protective film explained in Example 7 were used.

As for the application compositions, a cosmetic material used as mascara was placed on one side (side A) of the base sheet, while a cosmetic material for removing mascara was placed on the other side (side B) of the base sheet.

According to the manufacturing method explained above and illustrated in FIG. 13, an application implement was manufactured that had a structure where no bulkhead was provided to divide the surface on either side A or side B and a bag-shaped insertion area was provided where around two fingers could be inserted.

At the time of use before going out, the user inserted her fingers through the opening and first peeled off and removed the protective film on side A to apply the cosmetic material used as mascara, which was now exposed on the application surface, along the eyelashes. Since the application implement was worn directly on the fingers and the curved shape of the fingers nearly matched the curled shape of the eyelashes, mascara could be applied easily and detail areas could also be covered sufficiently. Because the cosmetic material was absorbed into the application base sheet, there was no dripping of excess cosmetic material.

After returning home, the user removed mascara by inserting her fingers through the opening and then peeling off and removing the protective film on side B, after which the exposed base sheet surface containing the cosmetic material for removing mascara was rubbed along the eyelashes to remove the attached cosmetic material used as mascara. Since the application implement was worn directly on the fingers, it was easy to operate.

Also, because the protective film could be peeled off and removed with ease and the barrier layer was provided on the inside of the empty area for inserting the fingers, the fingers did not become dirty during use.

1. A sheath-shaped application implement comprising:
a base sheet, a protective film, and one or more sealed compartments formed between the base sheet and the protective film for placing an application composition therein, wherein the protective film is removably sealed to the base sheet around its outer periphery; and
another base sheet to which the base sheet is sealed approximately around their outer peripheries so as to form an empty area therebetween for inserting the palm or fingers therein,
wherein the base sheet comprises a retention layer on which the application composition is placed, and a barrier layer laminated thereto for inhibiting the application composition from permeating or leaking to the empty area.

2. The sheath-shaped application implement according to claim 1, wherein the barrier layer of the base sheet faces the empty area so as to be contacted by the palm or fingers, and the base sheet is sealed to the another base sheet approximately around their outer peripheries, except for an opening, so as to form the empty area for inserting the palm or finger therein through the opening.

3. The sheath-shaped application implement according to claim 2, wherein the outer peripheries, which are sealed, except for the opening, are shaped nearly as a bag, mitten or glove.

4. The sheath-shaped application implement according to claim 1, wherein the one or more compartments provided on the base sheet contain at least one type of application composition inside.

5. The sheath-shaped application implement according to claim 1, wherein the application composition is placed on the retention layer in a line, lattice, or planar contact.

6. The sheath-shaped application implement according to claim 1, wherein at least one of the base sheet or the protective film has a color and/or printed pattern.

7. The sheath-shaped application implement according to claim 1, wherein the base sheet is a laminate constituted by a fiber sheet and/or sponge sheet as the retention layer and a resin sheet having a barrier function as the barrier layer.

8. The sheath-shaped application implement according to claim 1, wherein the application composition is included in the sealed compartments and is a composition selected form the group consisting of skin care cosmetic materials, cleansing cosmetic materials, makeup cosmetic materials, hair or scalp care preparations for external use, sun care cosmetic materials, tanning cosmetic materials, hair colors, cosmetic materials used as mascara, cooling agents and cleansing materials.

9. The sheath-shaped application implement according to claim 1, wherein the base sheet and/or the protective film contain(s) a biodegradable substance.

10. The sheath-shaped application implement according to claim 9, wherein the biodegradable substance comprises at least one type of constituent selected from the group consisting of polylactic acid, polycaprolactone, aliphatic polyester, bacteria-derived poly 3-hydroxy alkanate, polyamino acid, polyvinyl alcohol, pullulan, celluloses, and cellulose-chitosan mixtures.

11. A manufacturing method for sheath-shaped application implement comprising:
(i) placing a base sheet constituted by a retention layer and a barrier layer;
(ii) placing at least one type of application composition in at least one location on the retention layer;
(iii) as a first sealing step, performing sealing to form a closed area by overlaying the base sheet and the protective film on top of each other to cover the application composition;
(iv) as a second sealing step, further performing sealing to form an empty area for inserting the palm or finger therein by orienting the base sheet with its barrier layer facing inside; and
(v) cutting a material obtained in step (iv) so as to obtain a sheath-shaped application implement.

12. The manufacturing method for sheath-shaped application implement according to claim 11, wherein in the second sealing step, sealing is performed so that an opening for inserting the palm or fingers therethrough remains as a non-sealed part.

13. The manufacturing method for sheath-shaped application implement according to claim 11 12, wherein in the first sealing step, the protective film and the base sheet are sealed so that at least one compartment is formed.

14. The manufacturing method for sheath-shaped application implement according to claim 11, wherein the barrier layer is provided to inhibit the application composition from permeating or leaking to the palm or fingers.

15. The manufacturing method for sheath-shaped application implement according to claim 11, wherein steps (i) to (iii) are performed in parallel and the obtained two sheets are overlaid on top of each other with the protective films facing the outer side and then sealed in the second sealing step, after which step (v) is performed to cut the sheet assembly to a desired size for use.

16. The sheath-shaped application implement according to claim 1, wherein another protective film is removably sealed to the another base sheet around its outer periphery so as to form one or more sealed compartments therebetween for placing an application composition therein.
